(19) United States
(12) Patent Application Publication
(10) Pub. No.: US 2004/0117333 A1
(43) Pub. Date: Jun. 17, 2004

(54) Method and apparatus for building algorithms

(76) Inventors: Christos Voudouris, Ipswich (GB); Raphael Dorne, Ipswich (GB); Cedric Ladde, Dortan (FR)

Correspondence Address: Nixon & Vanderhye, 8th Floor, 1100 North Glebe Road, Arlington, VA, 22201-4714, US

(21) Appl. No.: 10/472,910

(22) PCT Filed: Apr. 3, 2002
(86) PCT No.: PCT/GB02/01533

(30) Foreign Application Priority Data
Apr. 6, 2001 (EP) 01303274.3

(51) Int. Cl. G06F 7/00; G06F 17/30; G06N 3/00; G06N 3/12; G06F 15/18; G09G 5/00

(52) U.S. Cl. 706/13; 707/3; 345/760

(57) ABSTRACT

The present invention is concerned with a system for building at least one algorithm to apply to an optimisation problem in order to find a solution to the problem, where the or each algorithm comprises a plurality of components. The system comprises:

means for creating parts corresponding to at least some of the components,

a store for storing the created parts, and

means arranged to select from said stored parts in order to build an algorithm therefrom,

wherein each part comprises co-operating means arranged to cooperate with other parts and effecting means arranged to effect a change to a solution to the optimisation problem, and wherein each part is arranged such that the effecting means is independent of the operation of any other part.

In addition, the system can include a graphical user interface arranged to display, in a first region, the parts stored in the store and to display, in a second region, a representation of said selected parts constituting the built algorithm, means responsive to movement of a part in the first region to the second region, and graphical connecting means arranged to graphically connect the moved part to one of the selected parts in the second region. Thus an algorithm can be built according to so-called drag-and-drop methods.

Moreover, the system can include means arranged to store the selected parts constituting the built algorithm as sets of information enclosed by tags of a hierarchical tag structure defined in accordance with a structured mark-up language, thereby saving a representation of the built algorithm. Preferably the structured mark-up language used is the eXtensible Markup Language.

The present invention relates to a method of building algorithms, and is particularly suitable for building algorithms that can be applied to solve real-world problems.

Most real-world problems are“NP-hard” type problems. This means that no exact method is known to exist that can guarantee optimal results to the problem in a reasonable amount of time; as a result “approximate, or approximative, methods” have been developed.

Various methods have been applied to solve these types of problems, the most successful, in terms of efficiency and breadth of applicability, being meta-heuristic methods. Meta-heuristic methods are essentially algorithms that use a heuristic function, or search strategy, to estimate the “cost” of moving from one solution to another solution, and move to new solutions based on the cost associated therewith.

However, due to the complexity involved, most of these methods are highly problem specific, so that, if a new problem is to be solved, a completely new algorithm is developed. Moreover the algorithms often require modifying by highly skilled experts, which makes it difficult to generate a general framework that can be utilised by non-experts.

According to one aspect of the present invention there is provided a system for building an algorithm to apply to an optimisation problem in order to find a solution thereto, the or each algorithm comprising a plurality of components, the system comprising:

means for creating parts corresponding to at least some of the components,

a store for storing the created parts, and

means arranged to select from said stored parts in order to build an algorithm therefrom,

wherein each part comprises co-operating means arranged to cooperate with other parts and effecting means arranged to effect a change to a solution to the optimisation problem, and wherein each part is arranged such that the effecting means is independent of the operation of any other part.

Advantageously each part includes a validation process arranged to validate interoperability between cooperating parts. Preferably the co-operating means includes an input and an output, and each input is arranged to co-operate with an output.

Preferably, the system can include a graphical user interface arranged to display, in a first region, the parts stored in the store and to display, in a second region, a representation of said selected parts constituting the built algorithm, means responsive to movement of a part in the first region to the second region, and graphical connecting means arranged to graphically connect the moved part to one of the selected parts in the second region. Thus an algorithm can be built according to so-called drag-and-drop methods.

Moreover, the system can include means arranged to store the selected parts constituting the built algorithm as sets of information enclosed by tags of a hierarchical tag structure defined in accordance with a structured mark-up language, thereby saving a representation of the built algorithm. Preferably the structured mark-up language used is the extensible Markup Language.

Advantageously the created parts include parts that effect a change to a solution to the optimisation problem.

Conveniently the change may include applying an incremental move to a current solution, commonly known as applying a “local search” to a solution.

Advantageously the change may involve performing operations on more than one solution to the optimisation problem, for example combining one of the generated solutions with at least one other generated solution. Such operations effect changes on solutions by means of “population-based methods”.

Preferably the system further includes identifying means for identifying components that are to constitute the or each algorithm. Such identifying means may include a manual means or may be automated by means of a computer program.

Conveniently, the system may also include means for comparing parts in the store with the identified components, so that, if a part corresponding to an identified component exists in the store, a part corresponding to the identified component is not created. This means that, for example, parts that are common to a first and a second algorithm, and have already been created in respect of a first algorithm, do not need creating for the second algorithm.

According to a second aspect of the present invention there is also provided a method corresponding to the system.

Conveniently the parts may be selected from one or more stores, so that the parts selected from which to build the algorithm the may originate from different stores.

The following is a glossary of terms that are used in the description:

Optimisation

Searching through a collection of possible solutions, usually under time constraints, with the aim of finding the best possible solution(s) according to (a) predetermined objective(s) (e.g. cost, reliability etc.).

Solution

Solutions may be represented as a set of values or set of decision variables, e.g. as a sequence of values. These values may, for example, be binary values.

Local search schemes/methods

A small change is applied to a current solution, so as to move from the current solution to a nearby solution. Different types of local search will differ in terms of the criteria used to determine whether or not the “nearby” solution then becomes the “current solution”. Examples of local search methods include Simulated Annealing and Hill Climbing.

Population based schemes/methods (such as Genetic algorithms)

A population of parent solutions interact with each other to produce a population of child (or offspring) solutions: the selection of parent solutions for interaction is often dependent on the quality of solutions, and the scheme by which they interact (e.g. type of crossover) is dependent on the problem. In addition to inter-solution interactions, mutations can be applied to the children. The new population of offspring solutions is then considered as a population of parents for the next iteration of the method. This is repeated many times in search of (a) solution(s) having optimal quality for the optimisation problem under consideration.

Objective Function

Function to be optimised, e.g. find s*=min{f(s)|sεS}, where f is an objective function with domain S, the set of possible solutions to a given problem, and s is one solution to the problem.

Neighborhood

A subset of S, designated N(s), may be associated with each solutions sεS. N(s) is referred to as the neighborhood of s.

Move

A move contains all pertinent information necessary for a Neighborhood N(s) to move from a current solution s to a destination solution s′.

Algorithm

A procedure for solving a problem.

Part

Computer code that can carry out operations such as search methods, where the search methods include local search or population-based search methods. The parts are standalone and can be joined with one or more other parts to form an algorithm.

Further aspects, features and advantages of the present invention will be apparent from the following description of preferred embodiments of the invention, which refer to the accompanying drawings, in which

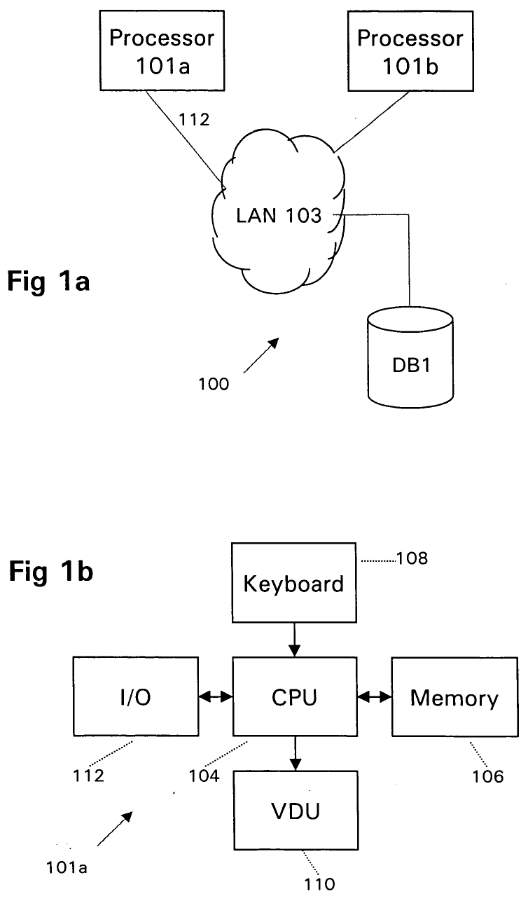

FIG. 1a is an illustrative block diagram of the environment in which embodiments of the invention operate;

FIG. 1b is an illustrative block diagram of a processor used by embodiments of the invention;

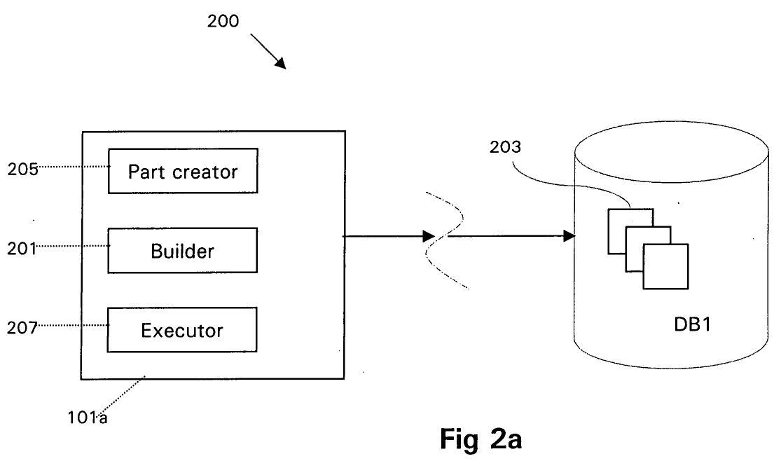

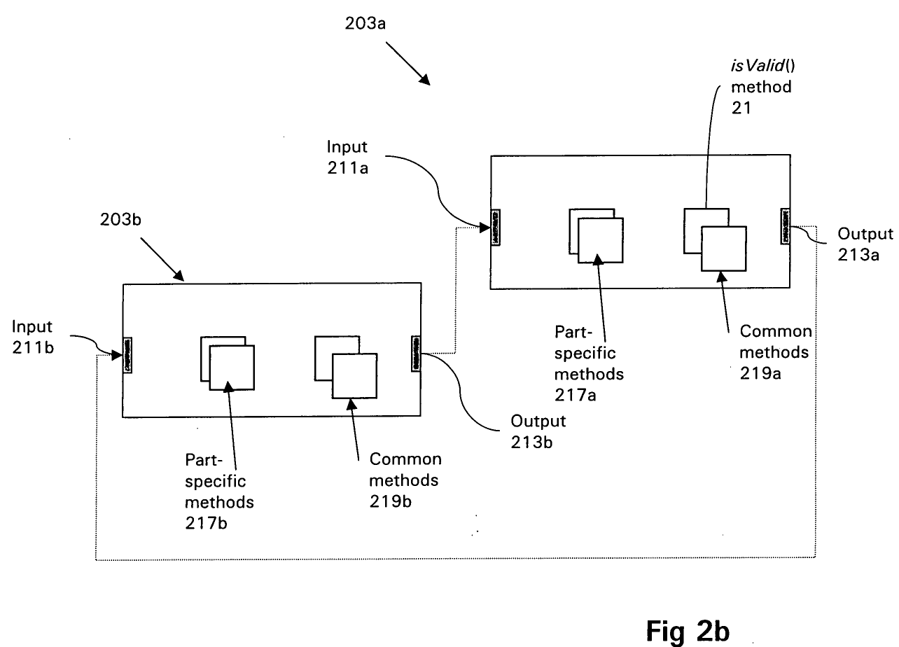

FIG. 2a is a schematic diagram showing a system for building algorithms according to an embodiment of the invention;

FIG. 2b is a schematic diagram showing a part according to an embodiment of the invention;

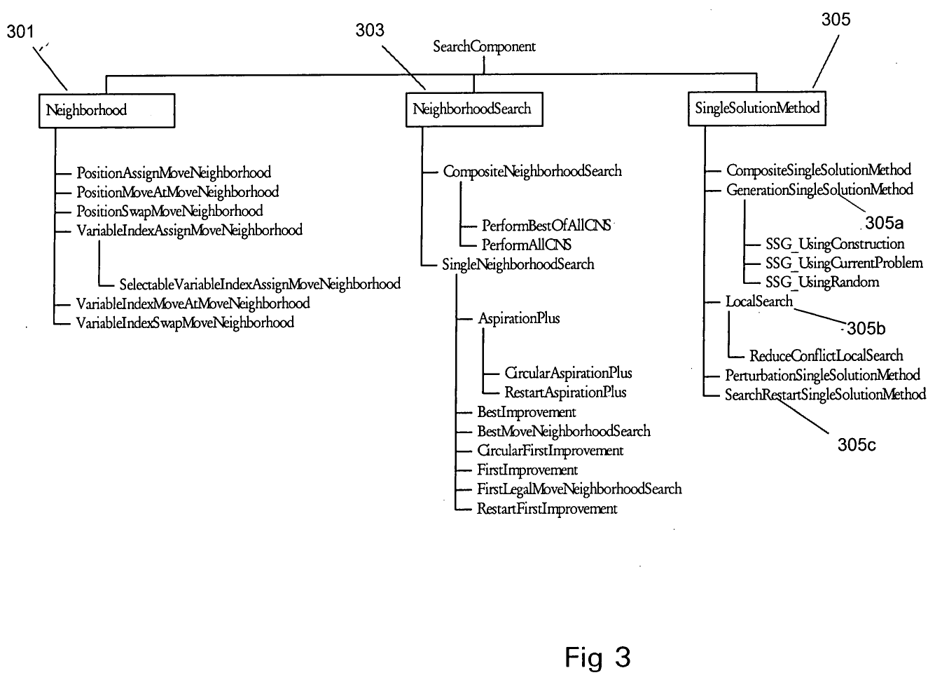

FIG. 3 is a hierarchical tree diagram showing parts that can be combined by the system of FIG. 2a to build single solution methods;

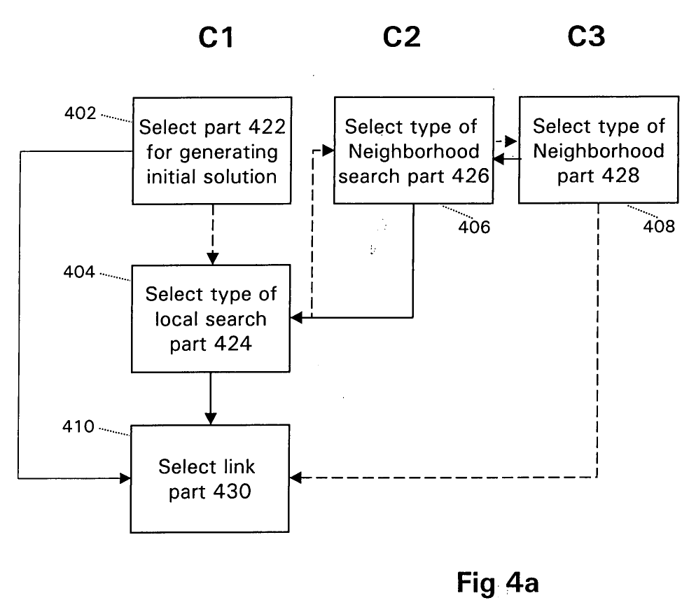

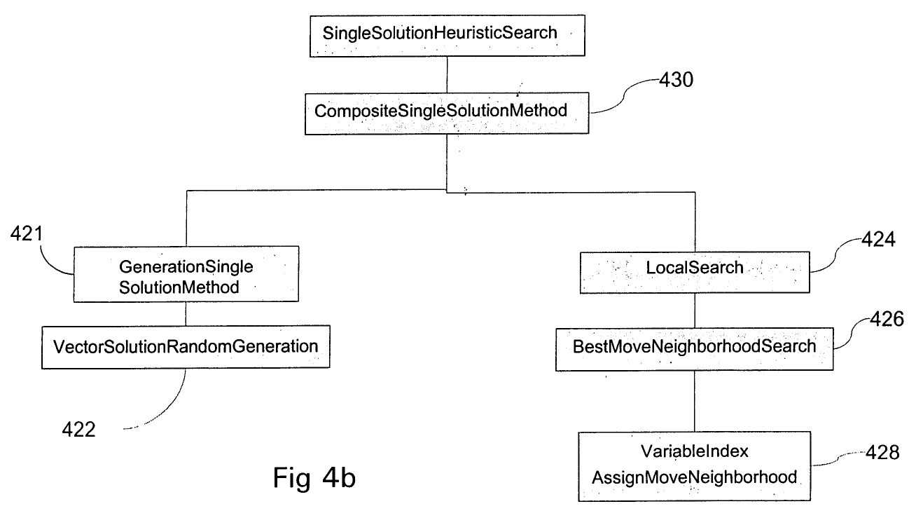

FIG. 4a is a flow diagram showing steps involved in selecting parts to be used in the creation of a hill-climbing algorithm according to an embodiment of the method of the invention;

FIG. 4b is a schematic tree diagram showing the parts selected using the method illustrated in FIG. 4a, and the relationship between these parts;

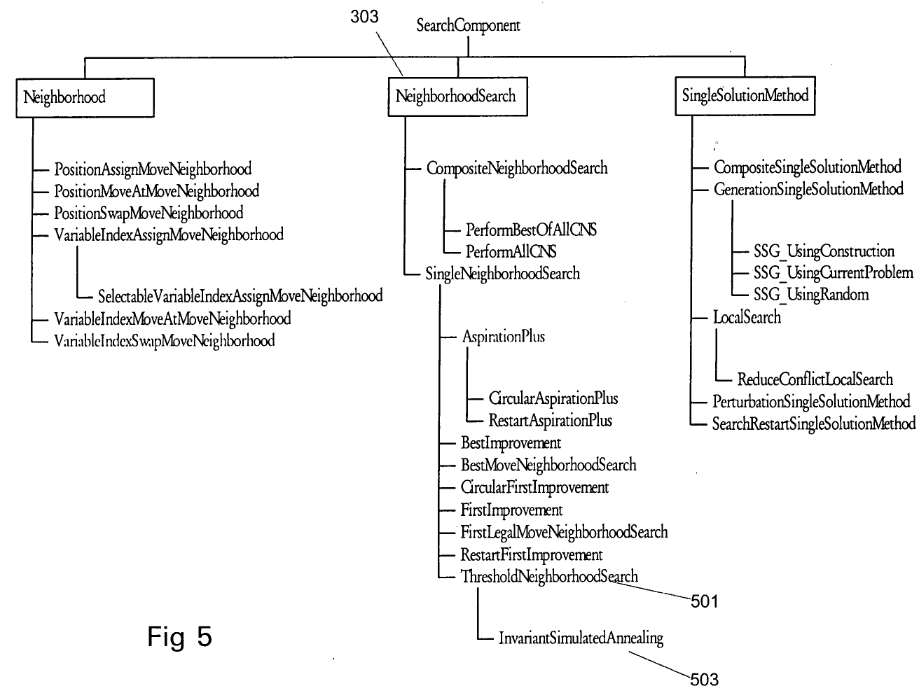

FIG. 5 is a revised tree diagram of FIG. 3, showing addition of new parts;

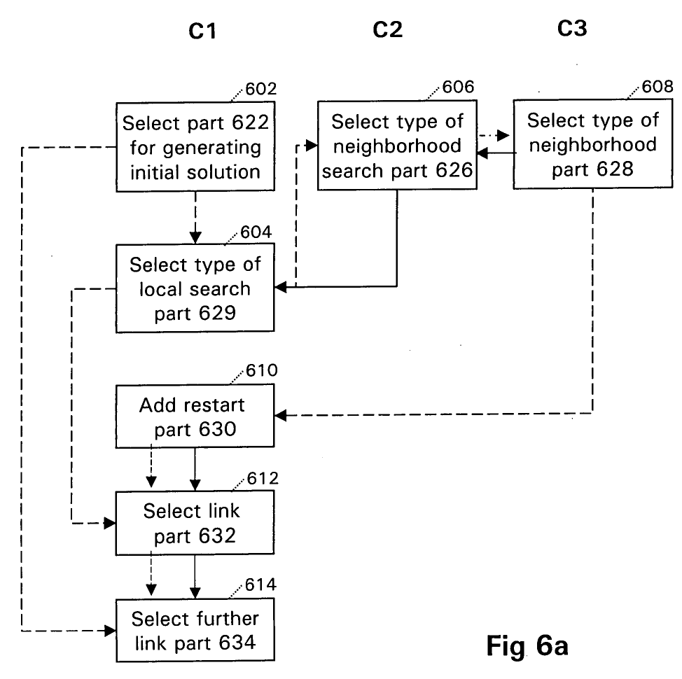

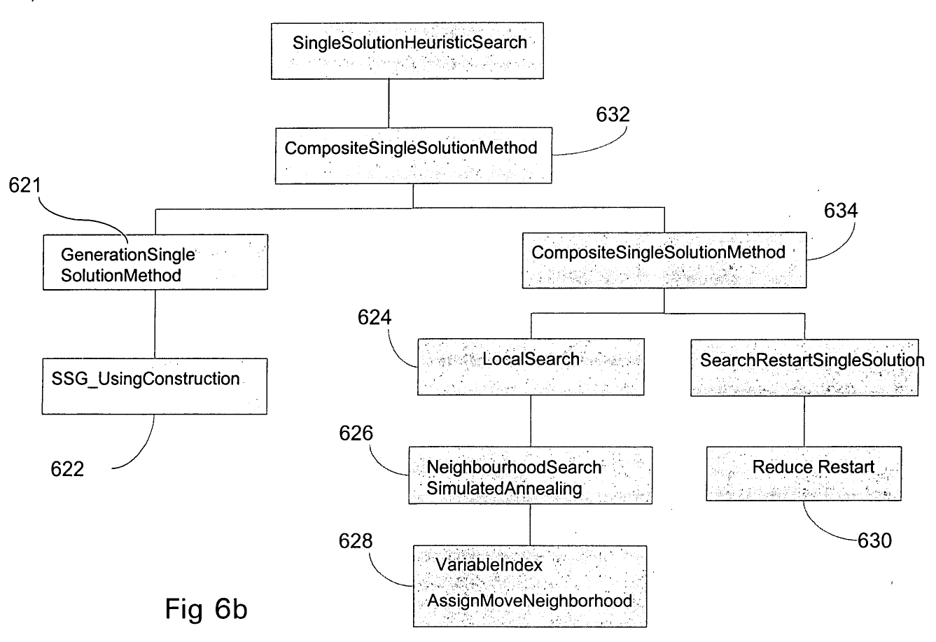

FIG. 6a is a flow diagram showing steps involved in selecting parts to be used in the creation of a Simulated Annealing algorithm applied to a Graph Colouring problem according to an embodiment of the method of the invention;

FIG. 6b is a schematic tree diagram showing the parts selected using the method illustrated in FIG. 6a, and the relationship between these parts;

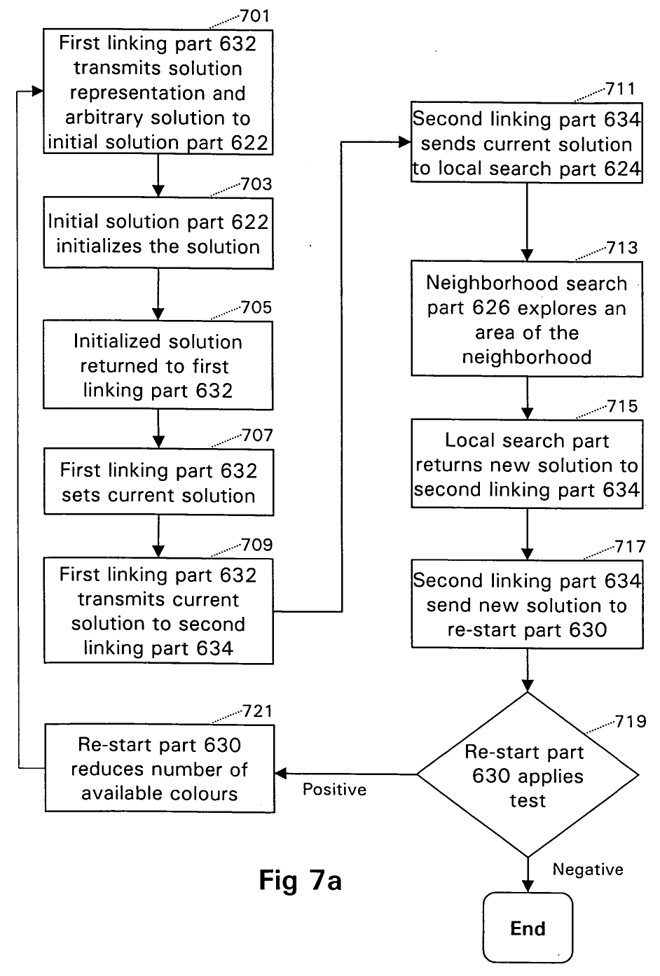

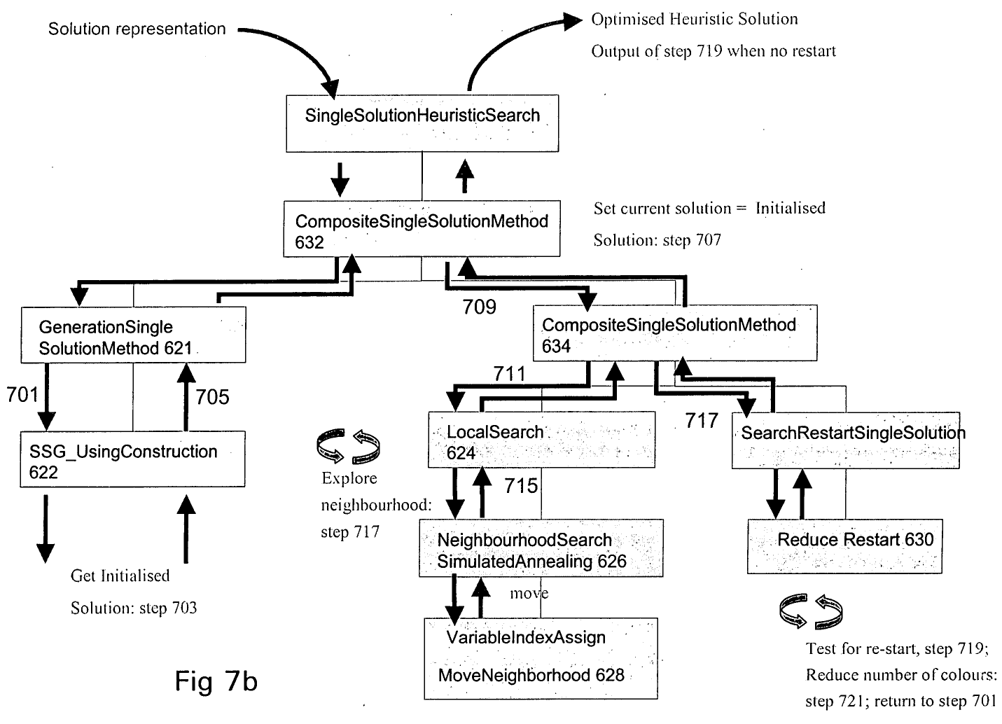

FIG. 7a is a flow diagram showing execution of the algorithm comprising the parts selected according to the method of FIG. 6a;

FIG. 7b is the schematic tree diagram of FIG. 6b with the steps shown in FIG. 7a superimposed thereon;

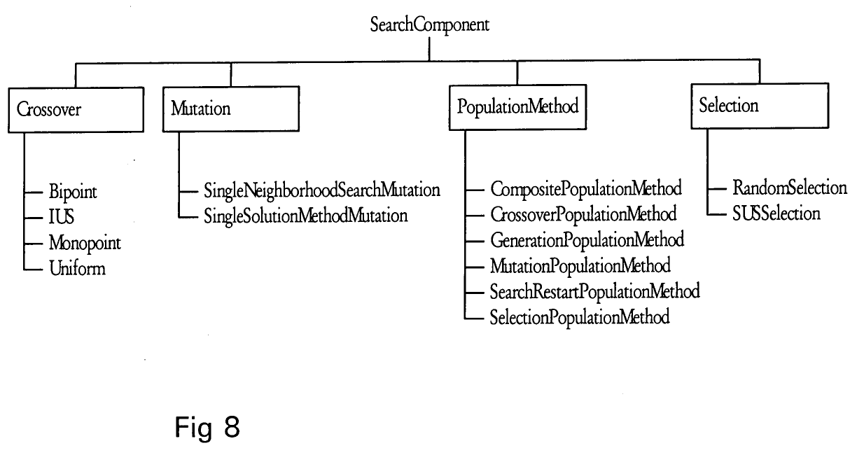

FIG. 8 is a hierarchical tree diagram showing population-based parts that can be combined by the system of FIG. 2a;

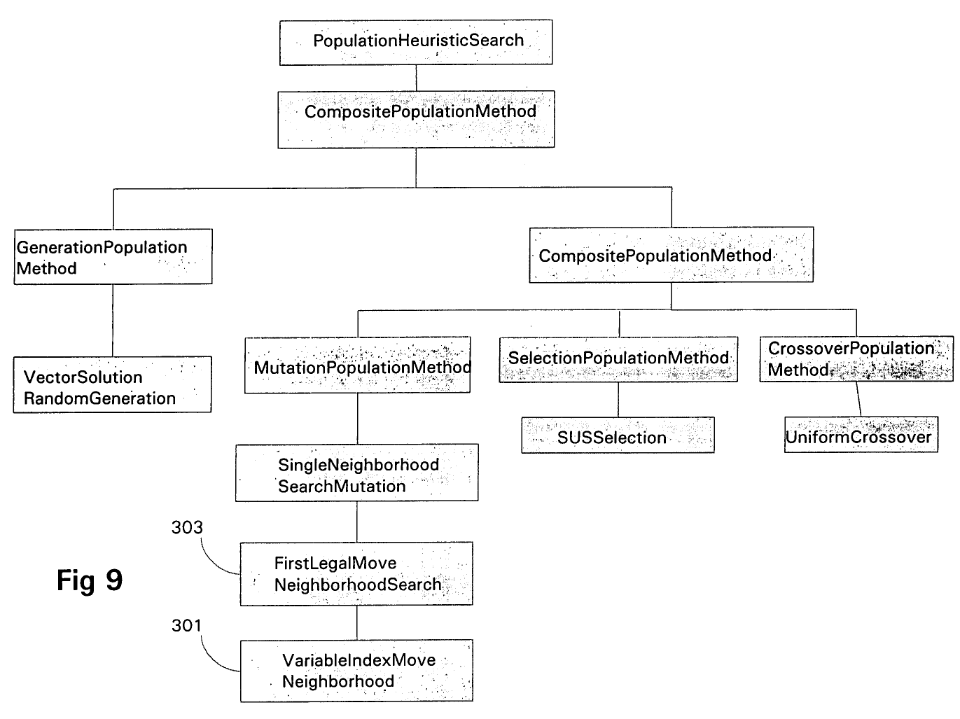

FIG. 9 is a schematic tree diagram showing the parts, and relationship between parts, selected to create a population-based algorithm;

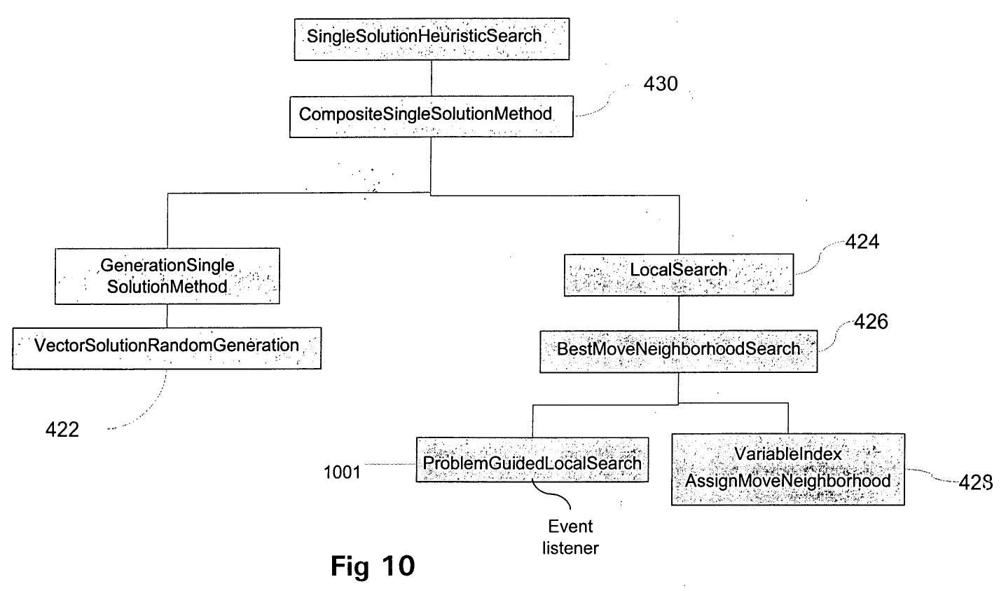

FIG. 10 is a schematic block diagram, extending the tree diagram shown in FIG. 4b to show use of an event handling part.

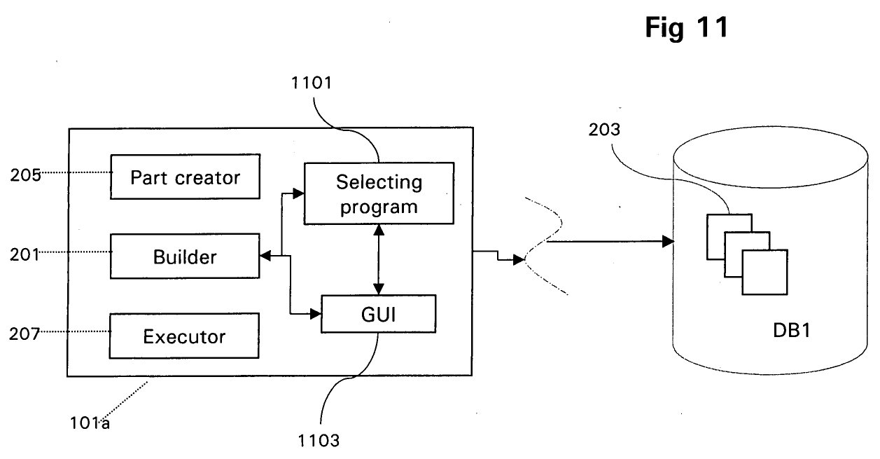

FIG. 11 is a schematic block diagram showing means for building an algorithm via a graphical user interface (GUI) in accordance with an embodiment of the invention;

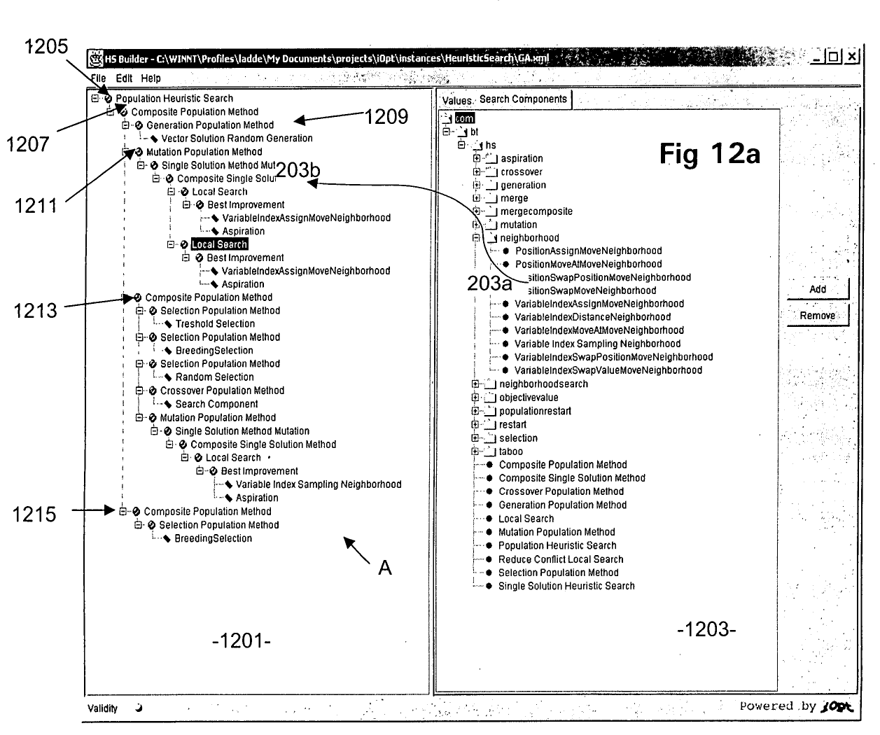

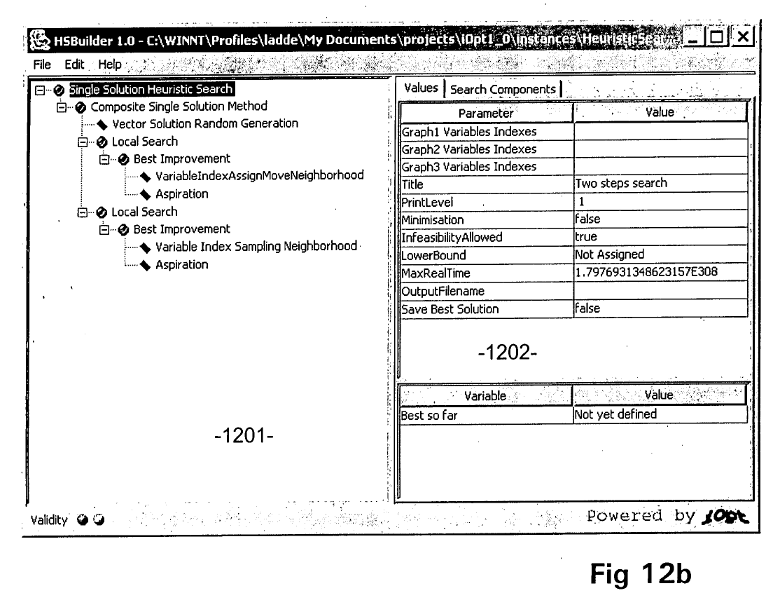

FIGS. 12a and 12b are screen-shots of the GUI forming part of the means shown in FIG. 11;

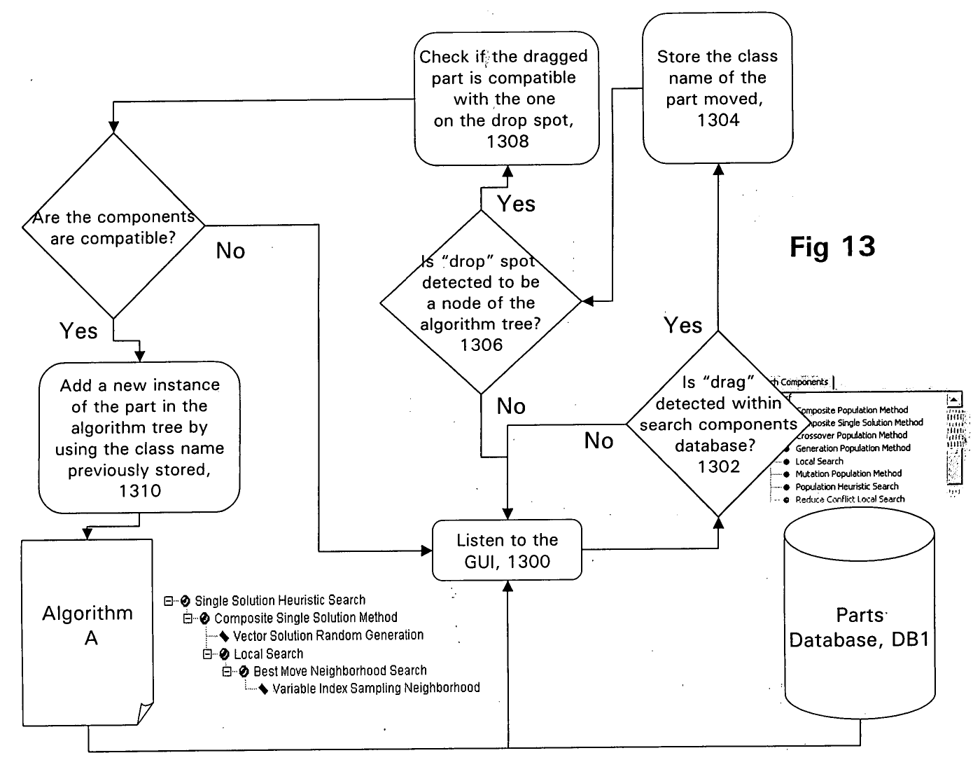

FIG. 13 is a flow diagram showing steps involved in building an algorithm using the GUI shown in FIG. 12; and

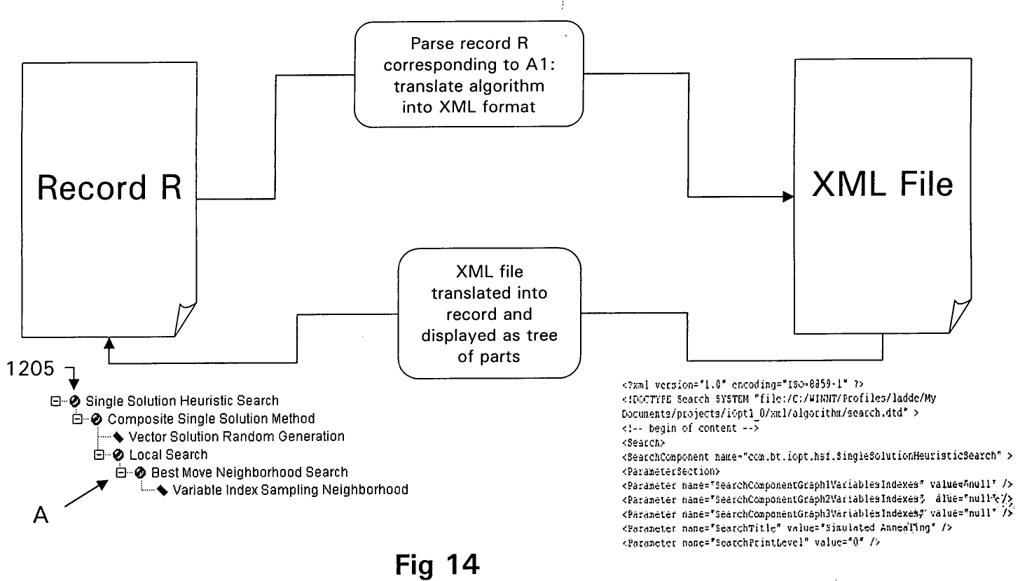

FIG. 14 is a schematic block diagram showing translation between GUI and XML representation.

In general, approximate methods of the type mentioned in the introduction rely on numerical methods, and are computer-intensive. Thus the range of approximate methods available, and the application of approximate methods to real-world problems, scales with computer power. Over the last decade computer power has been continually increasing, so people are increasingly trying to apply approximate methods, over an increasing range of problem types, to solve seemingly insoluble problems.

There is thus an ever-increasing incentive to generate methods that can make use of this computer power to generate solutions in a reasonable amount of time.

When approximate methods are applied to problems, a mathematical representation of the problem, termed a solution representation, is defined. Approximate methods are then applied to values populating this solution representation, which causes the values to vary. The performance of these values is evaluated by the Objective function, defined in the Glossary section, and a set of values (a solution) is accepted depending on the cost evaluated for those values. There are many ways of representing problems in this way, as is described in “Computers and intractability: a guide to the theory of NP-completeness”, by M. R. Garey and D. S. Johnson, publishers W. H. Freeman and Company, San Francisco, Calif., 1979, for further information.

With known systems, approximate methods are generally purpose built. This means that many implementations are redundant after use as they are difficult to modify for application to a new problem, so that a substantially new implementation has to be developed to solve a new problem.

In addition, traditional heuristic search systems rely on the user to define the objective function, and define methods implementing algorithms for solution evaluation and solution modification statically. This means that interrelationships between such methods are static. A problem with static code is that, if one aspect of the problem changes, then the whole, or a substantial part of the, code has to be reviewed in order to check compatibility of the changed aspects with residual ones. When so many aspects of a problem are coupled together the overhead associated with implementing, integrating and debugging both the logic and syntax can be significant (arguably making these tasks impossible) and is very time consuming. Furthermore, if the changed aspect involves, e.g. changing a population-based search method so that it no longer involves a crossover method, (and assuming that the problem is not required to be re-written from scratch), the crossover method in the static code has to be embodied using a “dummy” function, or its equivalent. This is clearly inefficient in terms of coding.

A further problem associated with static code of known problem solving systems is that the particular interrelationships between methods in static code can affect the ways in which the methods can be modified, which often constrains and limits the flexibility of the overall system.

Embodiments of the present invention are thus concerned with providing a more efficient framework for building approximate methods, hereinafter referred to as algorithms. Embodiments make use of the realisation that many algorithms can be broken down into a plurality of constituent parts, and that at least some of those parts are common between algorithms. For example, algorithm A could be considered as comprising parts a, b, c, j, while algorithm B could be considered as comprising a, j, k, m.

While with known systems, algorithms A and B are considered as independent algorithms, embodiments of the invention identify constituent parts, then look to see which of these parts are already available within the framework. These constituent parts can be considered to comprise a “library” of parts.

Embodiments of the invention include means for creating new parts—for example, if, with algorithm B, parts a and j already exist in the framework, but parts k and m do not, an entity, such as a user (more specifically an expert user), can create parts k and m. These parts are then added to the library and are available for future use by other algorithms.

Advantages of the embodiments include reduced development time, reusability of existing resources, and identification of errors resulting from transparency of algorithm composition.

A further advantage of embodiments of the invention results from having a range of parts in the library, and the ability to “plug-and-play” the parts together. As a result users can develop wide ranging types of algorithms in a relatively short period of time, because a user can develop new algorithms simply by plugging various parts together. Clearly, as the parts can be plugged together with minimal effort, different algorithms can be created and evaluated quickly.

Once the problem is available as a solution representation, algorithms created according to embodiments of the invention can be applied thereto. For the purposes of exemplifying aspects of the present invention, it is assumed that a predetermined solution representation is available.

With reference to FIG. 1a, a system 100 operating in accordance with embodiments of the invention comprises one or more processors 101a, 101b connected to a database DB1 over a Local Area Network (LAN) 103. Referring to FIG. 1b, each processor 101a, 101b is of a conventional form, comprising a central processing unit (CPU) 104, a memory unit 106, an input device comprising a keyboard 108 and an output device comprising a visual display unit (VDU) 110. An input/output device 112 connects the microcomputer 101a to the LAN 103.

The memory unit 106 comprises Random Access Memory (RAM) Memory (ROM). This memory can be provided as disc drives or solid state semiconductor memory or a combination of these. (In a UNIX based system this memory could also be distributed over a number of micro-computers in the system although it is convenient for descriptive purposes to consider it as being associated with one).

The keyboard 108 and VDU 110 enable a user to interact with the system 100. One embodiment of the invention, generally referred to as framework 200, is shown in FIG. 2a and essentially comprises a number of computer programs 201, 205, 207 running on at least one processor 101a. The computer programs include a builder 201, which co-operates with the database DB1 to retrieve previously created parts 203 stored therein, in accordance with predetermined instructions (e.g. from a user). The computer programs additionally include a part creator 205 for adding new parts to the database DB1. The framework 200 can be used to create an algorithm using the parts 203, and/or to define new parts 203, which are subsequently added to the database DB1 for use in creating new algorithms.

Embodiments can additionally include a program termed an executor 207 for executing algorithms built by the builder 201. However, as an alternative, the algorithms built by the builder 201 could be passed to a third party system for execution thereby.

It is understood that each of the programs 201, 205, 207 could comprise a suite a computer programs.

Description of a Part

Each part essentially performs a particular operation on a solution representation, so that parts 203 are categorised according to operation type. FIG. 2b shows an example of a part 203a, which has inputs 211a, outputs 213a and methods, which include methods 217a that are specific to the type of part (thus type of operation to be performed by the part) and methods 219a that are common to all parts. For any part 203a, its input 211 a is arranged to receive data indicative of other parts 203b that wish to be connected to the part 203a. Methods 219a common to all parts include a validity method 21 (isValid()), which receives data, via the input 211a, from the other parts 203b, and identifies whether or not the other part 203b can be connected thereto. If the validity method 21 deems the requested connection to be possible, the validity method 21 outputs, via the output 213a, data indicative of acceptance to the other part 203b. Connection between the parts 203a, 203b is effected when the algorithm built as described below is run, whereupon data is passed between connected parts via the inputs and outputs thereof 211a, 211b, 213a, 213b, and processed by methods 217a that perform operations on the data.

The methods 217a, 219a within a part 203a are completely hidden from the other parts so that each part 203 is seen by other parts as a black box. This means that, when methods 217a specific to the operation of a part 203a are modified, this modification does not affect the operation of other parts 203b (provided the format and type of data that is output is unchanged). A system that builds and utilises algorithms comprising these parts 203 is said to be “dynamic”, since, in comparison to the static systems of the prior art, there is no predetermined relationship between the parts 203, and, as parts 203 are connected together in real time, the functionality of an algorithm is determined dynamically.

Such organisation of parts lends itself to a system wherein parts 203 are specified, categorised and interrelated using an object-oriented language such as Java™.

When implemented using Java™, each part 203a is created as a child of a base class having one or more abstract, or virtual methods. Referring again to FIG. 2b, these abstract methods are those methods 219a that are common to all parts 203.

As will be appreciated by the skilled person, abstract methods exist only to provide a gateway to multiple different forms of a method, and are designed to be overridden (and only implemented) by a child class (parts 203). This mechanism is commonly referred to as polymorphism, and is described in detail in Part 4 of “Understanding Object-Oriented Programming with Java”, by Timothy Budd, publishers Addison-Wesley, 1998, ISBN 0-201-30881-9.

Such a base class is commonly termed an interface, and each child class (part) implements the virtual methods of the interface in accordance with the type of child (part). Appendix A1 lists a selection of methods that are declared as virtual methods in the interface, and, while being present in all parts, are implemented differently depending on the type of part 203a that is created (or instantiated).

Building an Algorithm from Parts

FIG. 3 shows an example of a hierarchy of parts, which can be used to create an algorithm according to an embodiment of the invention, stored in the database DB1. In terms of operation type, parts in the branch below the hierarchy heading “Neighborhood” 301 are Neighborhood type parts, which means that their methods 217 perform different types of moves on a solution (where, as defined in the Glossary section, a move defines all information required to enable a solution to move from s to s′).

Parts in the branch below the hierarchy heading “NeighborhoodSearch” 303 are Neighborhood Search type parts, which means that their methods 217 correspond to different strategies (or criteria) for selecting a move (and thus a particular solution s′) created by a “Neighborhood” part 301. An extended example of the hierarchy of parts is provided in Appendix A2.

The parts in the branch below the hierarchy heading “SingleSolutionMethod” 305 are parts that effect a change to the status of a solution—e.g. a part that creates (an) initial solution(s) (“GenerationSingleSolutionMethod” 305a), a part that initiates a change to be made to the or each solution (“LocalSearch” 305b), and a part that restarts the process of changing the or each solution (“SearchRestartSolutionMethod” 305c). In fact the parts in the branch below the heading “SingleSolutionMethod” 305 use parts 301, 303 below the other hierarchy headings, as explained below, with reference to FIGS. 4a and 5a.

The operation of the framework 200, when creating algorithms according to embodiments of the invention, will now be described with reference to the flowchart shown in FIG. 4a and the tree of search components in FIG. 4b.

The flowchart shown in FIG. 4a is for the specific example of building a general hill-climber search algorithm. The different columns in the FIG. C1, C2, C3 represent granularity levels of parts, so that the left hand column represents parts at the highest level of granularity, while the right hand column represents parts at the lowest level of granularity. The broken lines indicate the order of steps in the sequence. The full lines, which in the interests of clarity are reproduced in FIG. 4b, indicate the way in which the selected parts are linked together in the built algorithm. From FIG. 4b it can be seen that the built algorithm essentially comprises a tree of parts, having child-parent relationships with one another.

Referring to FIGS. 4a and 4b, at step 402 a part 422, which is a type of “GenerationSingleSolutionPart” 421, is selected. This part 422 can generate an initial solution s. At step 404 a type of change 305b to apply to the initial solution s is selected. This involves selecting a “LocalSearch” part 424, and constituents of the “LocalSearch” part, such as a part that is a type of NeighborhoodSearch part 426 at step 406, which in turn involves selecting a part that is a type of “Neighborhood” part 428 at step 408. Finally a linking part 430 is selected at step 410, for combining the initial solution part 422 with the local search part 424.

It is understood that a user can select these parts manually, or a selecting program can be configured to select the parts in accordance with instructions from the user. As described below (section entitled “selecting program”), such a selecting program could be implemented using XML (eXtensible Markup Language, version 1.0, W3C standard), so that the user could “drag-and-drop” parts relative to one another. Alternatively such a selecting program could be arranged to generate parts in accordance with high-level user requirements (so-called generative programming).

Creating New Parts

One of the objectives of embodiments is to provide the user with a library of parts that allows him to create any type of algorithm. To achieve this objective embodiments have a facility for adding new parts to the library. Typically a new part is added when a new algorithm is to be built, and the database DB1 does not include sufficient parts to enable the user to build the new algorithm. For example if a user wants to create a search algorithm comprising parts a, b, f and g, and the database DB1 does not include part g, part g is created.

This process therefore starts with identification of components of the new algorithm. This is typically a manual task, whereby the user identifies components that constitute said new algorithm. Parts are then created, by the part creator 205, which parts correspond to the identified components. This is described in more detail below.

This process may alternatively be carried out automatically, by a suitable program. Such a program would preferably allow a user to specify the new algorithm, then parse the algorithm specification and identify components corresponding to the specification. These components could be in the form of a tree of inter-related

components, which provides input to the part creator 205. The part creator 205 then creates parts corresponding to the components.

Such a facility is particularly advantageous in the field of approximate methods, where new algorithms are continually being developed and require evaluating over a wide range of problems. Parts can be “glued” together very easily (as described above) and in many different ways, to create many different types of algorithms. These algorithms can then be applied to a problem, so that the performance of the different algorithms, for that problem, can be evaluated very easily.

For the purposes of illustrating this feature of embodiments, new parts are added to the database DB1 of parts in respect of a particular problem and a particular type of algorithm. The problem is the “Graph Colouring” Problem, and the algorithm type is a Simulated Annealing algorithm.

The “Graph Colouring” Problem (or more specifically, the vertex colouring problem) is to label each vertex in a graph G with a colour such that no two adjacent vertices are labelled with the same colour and such that the minimum number of colours is used. In general, the graph colouring problem is NP-complete (i.e. a satisfaction problem), and it is impossible to find the optimal solution in a reasonable amount of time.

In terms of solution representation described above, the graph colouring problem can be described by a vector representation of integer decision variables. In such a representation, the i^{th} decision variable is an integer, where the value of that integer corresponds to the colour assigned to the i^{th} vertex.

Many different algorithm types can be applied to the Graph Colouring problem, but as stated above, for the purposes of this example, we consider application of the Simulated Annealing search method to implement the NeighborhoodSearch.

In accordance with the process described in one of the preceding paragraphs, the user first identifies components that constitute the algorithm that he wants to create. A Simulated Annealing search method comprises a particular form of NeighborhoodSearch, which satisfies a particular type of condition, or threshold test (for further information relating to the Simulated Annealing method, the reader is referred to “Modern Heuristic Techniques for Combinatorial Problems”, edited by C. R. Reeves and Published by John Wiley & Sons, Inc.).

Upon inspection of the parts in the database DB1, the user finds that the database DB1 does not include parts corresponding to this NeighbourhoodSearch component, so the part creator 205 creates one or more new parts, as necessary.

The part creator 205 either allows the user to explicitly create code corresponding to this/these part(s), or the part creator 205 automatically creates the part, based on a specification from the user. In either case, once these new parts have been created, they are added to the database DB1. Referring to FIG. 5, which shows a revised form of parts in the database DB1, two parts 501, 503 are added to the NeighborhoodSearch branch 303. These parts are:

ThresholdNeighborhoodSearch part (501): describes a specific NeighborhoodSearch strategy, which goes through all the potential neighbours (solutions) and selects the first one verifying a predetermined condition (which is part of the algorithm specification).

InvariantSimulatedAnnealing part: (503) extends ThresholdNeighborhoodSearch part, essentially overriding the predetermined condition specified for the ThresholdNeighborhoodSearch part 501 in order to redefine it as the classic SimulatedAnnealing acceptance criterion, known to those skilled in the art (and described in the Simulated Annealing reference provided above).

Example of Building an Algorithm Using Newly Added Parts

Now that these parts have been added to the database, they can be used to build a Simulated Annealing algorithm for the Graph Colouring Problem, as shown in the flowchart of FIG. 6a. The different columns in the flowchart (C1, C2, C3) represent granularity levels of parts, so that the left hand column represents parts at the highest level of granularity, while the right hand column represents parts at the lowest level of granularity. As for FIG. 4a, the broken lines indicate the order of steps in the sequence. The full lines, which in the interests of clarity are reproduced in FIG. 6b, indicate the way in which the selected parts are linked in the built algorithm. From FIG. 6b, as for FIG. 4b, it can be seen that the built algorithm essentially comprises a tree of parts, associated by child-parent relationships.

Referring to FIGS. 6a and 6b at step 602 a part 622, of the type “GenerationSingleSolutionPart” 621, is selected that can generate an initial solution s. At step 604 a type of change 305b to apply to the initial solution s is selected. As for FIG. 4a, this involves selecting “LocalSearch” part 624, and constituent parts of the “LocalSearch” part, such as a part which is a type of NeighborhoodSearch part 626 at step 606, which in turn involves selecting a part which is a type of “Neighborhood” part 628 at step 608.

At step 610 a restart part 630 is added (A restart method reduces the number of available colours by one and is necessary here as a Graph Colouring problem is considered as a sequence of k-Colouring problems where k is the number of colours used to colour the graph. Thus each time a complete colouring is found, the restart method reduces the number of available colours by one), and a linking part 632 is selected at step 612, for combining the restart part 630 with the local search part 624. Finally a further linking part 634 is selected at step 614 for combining the initial solution part 622 with the output of part 632.

Once the user, or selecting program (described below), has selected parts from the database DB1, the builder 201 “glues” the selected parts together in accordance with the relationship between the parts. This process is exemplified by the Java code reproduced below, which corresponds to the selected parts of FIGS. 6a and 6b:

Public static void graphModel( )
// creates problem instance: solution representation of problem to be solved
HP_Coloring myColoring = new HP_Coloring( );
myColoring.setProblem(myGraph);
// creates constructive method to generate initial solution part 622
(myCSSG)
boolean[] assignable = null;
SSG_UsingConstruction myCSSG = new SSG_UsingConstruction( )
// create a neighborhood search part 626 (myRMNS)
InvariantSimulatedAnnealing myRMNS =

new InvariantSimulatedAnnealing ( );

myRMNS.setMaxMovesEvaluated(250);
// creates a neighborhood part 628 (myNeighborhood)
VariableIndexAssignMoveNeighborhood myNeighborhood

= new VariableIndexAssignMoveNeighborhood( );

myNeighborhood.setMovesVersion(2);
myRMNS.setNeighborhood(myNeighborhood);
// creates a new local search part 624 (myLS)
LocalSearch myLS = new LocalSearch( );
myLS.setNeighborhoodSearch(myRMNS);
myLS.setMaxMovesPerformed(10000);
myLS.setMaxMovesEvaluated(100000);
myLS.setThreshold(0.0);
// creates restart search part 630 (myRestart)
ReduceRestart myRestart = new ReduceRestart( );
SingleSolutionSearchRestart mySSSR =
new SingleSolutionSearchRestart( );
mySSSR.setSearchRestart(myRestart);
// creates first composite search part 632 (myCSSM1)
CompositeSingleSolutionMethod myCSSM1 =

new CompositeSingleSolutionMethod( );

myCSSM1.addMethod(myCSSG);
myCSSM1.setMaxIterations(1);
// creates second composite search part 634 (myCSSM2)
CompositeSingleSolutionMethod myCSSM2 =

new CompositeSingleSolutionMethod( );

myCSSM1.addMethod(myCSSM2);
myCSSM2.addMethod(myLS);
myCSSM2.addMethod(mySSSR);
myCSSM2.setMaxIterations(4);
// Glue it all together into a heuristic search algorithm:
SingleSolutionHeuristicSearch mySSHS =

new SingleSolutionHeuristicSearch( );

mySSHS.setSingleSolutionMethod(myCSSM1);
}

As stated above, embodiments of the invention can include executor 207, for executing the built algorithm. Clearly the way in which the algorithm is executed is highly dependent on the way in which it is “glued” together. For the tree of parts shown in FIG. 6b, to which the code above relates, the executor 207 performs the following steps:

Referring to FIGS. 7a and 7b, the executor 207 starts with the “root” of the algorithm, which is first linking part myCSSM1 632, and, following a depth-first exploration process (described in “Artificial Intelligence—A Modern Approach” by S. Russell and P. Norvig, Prentice Hall, USA), passes 701 the solution representation and an arbitrary solution to its first child part. As can be seen from FIG. 6b, the first child is the initial solution parts 621, 622, so that the initial solution part myCSSG 622 initialises 703 the solution. The initial solution part myCSSG 622 returns 705 the initialised solution, whereupon the first linking part myCSSM1 632 sets 707 the current solution to the initialised solution.

The first linking part myCSSM1 632 then passes 709 the current solution to its next child, which is itself another linking part myCSSM2 634.

The second linking part 634 sends 711 the current solution to its first child, local search part myLS 624, which has as its child the NeighborhoodSearch part myRMNS 626. This causes the NeighborhoodSearch part myRMNS 626 to explore 713 an area of the neighborhood, in accordance with the particular Neighborhood part myNeighborhood 628.

Once the local search part 624 has completed, it returns 715 the new solution to the second linking part myC55M2 634, whereupon the new solution is passed 717 to the restart part mySSR 630. The restart part 630 tests 719 if the colouring solution returned by the local search is complete in k colours (i.e. all nodes are assigned with one of the k available colours without any conflict: a complete colouring with k colors). If the test is positive the restart part 630 reduces 721 the number of colors available to k−1, and this is sent back to the first linking part 632 to repeat the process detailed in FIG. 7a. If the test is negative the restart part 630 does nothing and the solution is considered to be optimized for this problem.

Other Embodiments

Types of Algorithms

In the embodiments described above, the parts 203 correspond to single solution methodologies—i.e. parts that apply a small change to a current solution, so as to move from the current solution to a nearby solution.

In other embodiments the database DB1 includes parts 203 corresponding to population-based methodologies—i.e. where a population of parent solutions interact with each other to produce a population of child (or offspring) solutions: the selection of parent solutions for interaction is often dependent on solution quality, and the scheme by which they interact (e.g. type of cross-over) is dependent on the problem.

FIG. 8 shows an example of parts 203 that can be selected to create a population-based algorithm.

In addition to inter-solution interactions, mutations, which are selected randomly, can be applied to the children. Thus an algorithm, which is a mixture of single solution and population-based parts, can be created. For example a single solution part, such as a NeighborhoodSearch part 303 can be plugged into a population-based algorithm as a mutation.

FIG. 9 shows an example of a Genetic Algorithm built using this embodiment of the invention (population based parts integrating NeighborhoodSearch 303 and Neighborhood 301 parts to create the Genetic algorithm), applying the same method as described above with reference to FIGS. 4a and 6a.

Form of Solution

The form of the solution (that is input to, initialised, updated and output by the various parts) should be sufficiently flexible so that it can accommodate any type of solution representation (i.e. any type of problem). Preferably the solution comprises an object having at least some of the following attributes:

A data type and a data object index that references values in a data structure (representing a vector, a list, a list of lists, a matrix . .). i.e. the data object index references an element in the data structure, and the data structure includes a solution value which is of type data type.

Whatever form the solution takes, the parts 203 preferably comprise corresponding attributes so that they can receive and update the solution. For example, with the solution object described above, which has vector and sequence attributes, corresponding vector and sequence representations are included in Neighborhood parts 301.

e.g. with the Graph colouring problem described above, the solution form comprises data type colour, an index to the nodes to be coloured, and a vector of i integer values, each of which represents the colour assigned to a node.

The Neighborhood part 301 VariableAssignMoveNeighborhood includes an attribute that receives a vector representing the nodes, and, among other things, includes a method that changes the colours assigned to the nodes (where a move stores the node index and the new colour value).

The output of this Neighborhood part 301 is thus a vector of values, each of which comprises a colour value corresponding to a unique node in the vector.

Dynamic Event Handling

Embodiments of the invention can also include event handler parts, an example of which is shown in FIG. 10 as Problem Guided Local Search 1001. The event handler parts can be plugged into any of the parts, trap events at the level of that plugged part, and cause various actions to be performed.

The example part 1001 shown in FIG. 10 specifically works as a “guided local search” mechanism, plugging into a NeighborhoodSearch part, checking for certain conditions, and making modifications to the objective function during the search process. This essentially enables dynamic modifications to be made to the objective function in a controlled manner, i.e. part way through running of the algorithm.

Other event handlers can be developed, which operate with other types of parts, and, according to the type of event that has been trapped, can perform certain actions on the solution.

Selecting Program

In an embodiment of the invention, an algorithm can be created by means of a selecting program, which is embodied as a “Drag-and-drop” application accessible via a Graphical User Interface (GUI). As is known to those skilled in the art, drag-and-drop facility describes an application that allows a user to drag objects to specific locations on a user interface, whereupon certain actions are performed on the dropped objects.

As shown in FIG. 11, the selecting program 1101 interoperates with a GUI 1103, the database DB1 and builder 201. When the embodiment is implemented in the Java™ programming language, the selecting program 1101 extends classes and methods provided in Java's Application Windows Toolkit™ (AWT) DragSourceListener interface. This interface is part of the drag-and-drop package java.awt.dnd and defines an interface for originators of Drag-and-Drop operations to track the state of a GUI input, and to provide appropriate “drag over” feedback to the user throughout

the Drag-and-Drop operation. The methods making up this interface are reproduced in Appendix A3, and further information is available from Sun Microsystems™ at http://java.sun.com/j2se/1.4/docs/api/java/awt/dnd/DragSourceListener.html. In addition to extending the methods reproduced in Appendix A3, the selecting program 1101 includes methods that perform certain actions in respect of the parts 203 in response to a user drag-and-drop.

These methods are best described with reference to FIGS. 12a, 12b and 13, which show, respectively, the GUI 1103 within which the selecting program 1101 operates, data viewable via the GUI 1103, and the steps involved in dragging and dropping parts into an algorithm. Referring firstly to FIG. 12a, the GUI displays, on the left hand side 1201, an algorithm A comprising many different parts, and on the right hand side 1203, parts 203 as they are stored in the database DB1. The user can drag a component from the database DB1 and drop it onto a part that is already part of the algorithm A. This is controlled by the selecting program 1101, as described with reference to FIG. 13:

The selecting program 1101 continually listens 1300 for user input via the GUI, and, when a “drag” input is received, it identifies 1302 whether the drag input has been effected within the right hand side 1203 of the GUI, namely in respect of a part 203 in the database DB1. Assuming this to be the case, the selecting program 1101 identifies and stores 1304 the class name of the part 203a (VariableAssignlndexMoveNeighbourhood) that has been moved by the user and identifies 1306 the drop spot of that part 203a. Assuming the drop spot to fall within the left hand side 1201 of the GUI, the selecting program 1101 identifies a part 203b at the drop spot (Bestimprovement) and checks 1308 whether the dragged part 203a is compatible with that part 203b.

In one arrangement this compatibility check (step 1308) involves sending, to the part 203b, an identifier representative of the dragged part 203a, such as a class name. The part 203b then creates an instance of the dragged part 203a, using the class name, and checks if this instance inherits from the class listed as compatible therewith (within the part 203b), and, if the class of the dragged part 203a is deemed to be compatible, the part 203b outputs a valid signal to the selecting program 1101. This causes the builder 201 to add 1310 a new instance of the part 203a in the algorithm tree A. The selecting program 1101 maintains a record (e.g. a structure) R of the parts thereof, and the interrelationship therebetween, and, each time a part is added to the algorithm A, the selecting program 1101 updates the record R. This record R can be thought of as a parent/child chain of parts.

If either the drag is detected to be within another region of the GUI, or the drop is detected at a spot other than on the left hand side 1201 of the GUI, or the dragged part is deemed to be incompatible with that designated by the mouse, the selecting program 1101 returns to listening 1300 for GUI events.

Once the user has finished building his algorithm A, the builder 201 performs a validity check on the parts in the algorithm A. This involves selecting the part 1205 at the root of the algorithm A, and invoking the isValid( ) method local to the root part 1205. If the method is valid in respect of this root part 1205, the root part invokes the isValid( ) method local to part(s) connected thereto 1207, and, if this method(s) is/are deemed to be valid, this part 1207 invokes the isValid( ) method local to parts connected thereto 1209, 1211, 1213, 1215. This process repeats until all parts in the algorithm A have been tested. If, at any point, a part is deemed to be invalid, the user is informed by means of a dialogue box, or its equivalent.

The skilled person will appreciate that the validation process applies equally well to the first embodiment—i.e. where the parts are added by the builder 201 with manual input from a user.

Parameters characterising the parts 1205, 1207, 1209 etc. can be retrieved and viewed on the GUI 1103 in response to user input. Referring to FIG. 12b, when the user selects a part 1205, parameters 1211 relating thereto are retrieved by the selecting program 1101 and sent to the GUI 1103 for display thereby. Accordingly, in response to the user selection, the selecting program 1101 calls s.getParameters( ) (where s is selected part 1205), which, for a SingleSolutionHeuristicSearch part 1205, causes the parameters to be retrieved from the part 1205 and displayed by the GUI 1103 in areas 1202.

Once an algorithm has been built and validated (or simply built and not validated)it can be saved as an extensible Markup Language (XML) file. That is to say, the names of the parts making up the algorithm and parameters thereof can be written as a flat file in XML. As is appreciated by those skilled in the art, XML provides a flexible and structured means for annotating information. Whereas all tags

within the well-known HTML markup language are standardised, XML tags are, but for a small core of standard tags, entirely user-definable. XML thus allows user communities to develop an individual mark-up language that best suits their needs.

Embodiments of the present invention utilise an ontology whereby XML tags specify features of the parts—e.g. type of part and operating parameters. The ontology is described in Appendix A4.

The GUI 1103 includes a menu option that, when selected by a user, causes the selecting program 1101 to generate an XML file describing parts 1205, 1207, 1209 etc. making up the algorithm A. This process is now described, with reference to FIG. 14. The selecting program 1101 retrieves the record R describing the parts making up the algorithm (which, as described above, is updated by the selecting program 1101 each time a part is added to the algorithm A) and parses the record R. This parsing step can be implemented in many ways, as will be appreciated by the skilled person. In one arrangement, it involves stepping through each part in the record R, and retrieving certain information relating thereto. This information is retrieved via methods that are common to all parts (see FIG. 2b: methods 219), so the same “name” method can be called for each part. Thus as the selecting program 1101 steps through the parts it will automatically retrieve and/or manipulate information that is appropriate to the part in question.

Essentially these methods identify parameters and/or variables characteristing the part, and this information is written to an XML file. The following pseudo-code is an example of steps involved in parsing the record R:

static void translateToXML(int level, SearchComponent s, PrintWriter out)
...
print to XML file (“<SearchComponent name=\“” +
s.getClass( ).getName( ) + “\” >”);

\\ s refers to the part currently under consideration in the record R (which will be the root part 1205 initially) and getClass( ) and getName( ) are methods 219 common to all parts

write to XML file (“<ParameterSection>”);

for (int i = 0; i < s.getNOfParameters( ); i++) {

write to XML file (“<Parameter name=\“” + s.getXMLParameterName(i)) + “\”

value=\“” + s.getParameterValue(i) + “\” />”);

}

\\ i.e. for all parameters of the part currently under consideration in the record R, retrieve the name of the parameter and values thereof, and write them to the XML file.

SearchComponent currentChild;
Iterator iterator = s.getChildren( ).iterator( );

\\ retrieve child of part currently under consideration in the record R and set that equal to the next part under consideration

while (iterator.hasNext( )) {

currentChild = (SearchComponent) iterator.next( );
translateToXML(level + 1, currentChild, out);

\\ call function again, with the retrieved child as search component

Thus the parsing step is essentially a recursive process. When the selecting program 1101 parses a record R corresponding to algorithm A shown in FIG. 14, the following data is written to a file (the tags starting <! . . . > relate to aspects of the XML ontology, which is described in Appendix A4):

<?xml version=“1.0” encoding=“ISO-8859-1” ?>
<!DOCTYPE Search [
<!ELEMENT Search (Description? , SearchComponent) >
<!ATTLIST Search xmlns CDATA #FIXED “http://isr.info.bt.co.uk/icsr” >
<!ELEMENT Description (#PCDATA)>
<!ELEMENT SearchComponent ( ParameterSection,SearchComponent* ) >
<!ATTLIST SearchComponent name CDATA #REQUIRED >
<!ELEMENT ParameterSection (Parameter*) >
<!ELEMENT Parameter EMPTY >
<!ATTLIST Parameter

name CDATA #REQUIRED
value CDATA #REQUIRED >

]>
<!-- begin of content -->
<Search>
<SearchComponent name=“com.bt.iopt.hsf.SingleSolutionHeuristicSearch” >
<ParameterSection>
<Parameter name=“SearchComponentGraph1VariablesIndexes” value=“null” />
<Parameter name=“SearchComponentGraph2VariablesIndexes” value=“null” />
<Parameter name=“SearchComponentGraph3VariablesIndexes” value=“null” />
<Parameter name=“SearchTitle” value=“Hill Climber” />
<Parameter name=“SearchPrintLevel” value=“0” />
<Parameter name=“SearchMinimisation” value=“false” />
<Parameter name=“SearchInfeasibilityAllowed” value=“true” />
<Parameter name=“SearchLowerBound” value=“Not Assigned” />
<Parameter name=“SearchMaxRealTime” value=“1.7976931348623157E308” />
<Parameter name=“SearchOutputFilename” value=“null” />
<Parameter name=“SearchSaveBestSolution” value=“false” />
</ParameterSection>

<SearchComponent name=“com.bt.iopt.hsf.CompositeSingleSolutionMethod” >
<ParameterSection>
<Parameter name=“SearchComponentGraph1VariablesIndexes” value=“null” />
<Parameter name=“SearchComponentGraph2VariablesIndexes” value=“null” />
<Parameter name=“SearchComponentGraph3VariablesIndexes” value=“null” />
<Parameter name=“SingleSolutionMethodMaxIterations” value=“1” />
<Parameter name=“SingleSolutionMethodThreshold” value=“Not Assigned” />
</ParameterSection>

<SearchComponent name=“com.bt.iopt.hsf.generation.VectorSolutionRandomGeneration” >
<ParameterSection>
<Parameter name=“SearchComponentGraph1VariablesIndexes” value=“null” />
<Parameter name=“SearchComponentGraph2VariablesIndexes” value=“null” />
<Parameter name=“SearchComponentGraph3VariablesIndexes” value=“null” />
<Parameter name=“SingleSolutionMethodMaxIterations” value=“1” />
<Parameter name=“SingleSolutionMethodThreshold” value=“Not Assigned” />
</ParameterSection>
</SearchComponent>
<SearchComponent name=“com.bt.iopt.hsf.LocalSearch” >
<ParameterSection>
<Parameter name=“SearchComponentGraph1VariablesIndexes” value=“4 5 ” />
<Parameter name=“SearchComponentGraph2VariablesIndexes” value=“null” />
<Parameter name=“SearchComponentGraph3VariablesIndexes” value=“null” />
<Parameter name=“SingleSolutionMethodMaxIterations” value=“1” />
<Parameter name=“SingleSolutionMethodThreshold” value=“Not Assigned” />
<Parameter name=“LocalSearchMaxMovesEvaluated” value=“9223372036854775807” />
<Parameter name=“LocalSearchMaxMovesPerformed” value=“9223372036854775807” />
<Parameter name=“LocalSearchMaxIllegalMoves” value=“9223372036854775807” />
<Parameter name=“LocalSearchMaxRealTime” value=“1.7976931348623157E308” />
</ParameterSection>

<SearchComponent

name=“com.bt.iopt.hsf.neighborhoodsearch.BestMoveNeighborhoodSearch” >

<ParameterSection>
<Parameter name=“SearchComponentGraph1VariablesIndexes” value=“0 ” />
<Parameter name=“SearchComponentGraph2VariablesIndexes” value=“1 ” />
<Parameter name=“SearchComponentGraph3VariablesIndexes” value=“0 1 ” />
<Parameter name=“NeighborhoodSearchMaxFailedAttempts” value=“100” />
<Parameter name = “NeighborhoodSearchMaxMovesEvaluated”

value=“9223372036854775807” />

<Parameter name=“NeighborhoodSearchMaxMovesPerformed” value=“1” />
<Parameter name=“NeighborhoodSearchMaxIllegalMoves” value=“9223372036854775807” />
<Parameter name=“NeighborhoodSearchThreshold” value=“Not Assigned” />
</ParameterSection>

<SearchComponent

name=“com.bt.iopt.hsf.neighborhood.VariableIndexAssignMoveNeighborhood” >

<ParameterSection>
<Parameter name=“SearchComponentGraph1VariablesIndexes” value=“null” />
<Parameter name=“SearchComponentGraph2VariablesIndexes” value=“null” />
<Parameter name=“SearchComponentGraph3VariablesIndexes” value=“null” />
<Parameter name=“NeighborhoodNumberOfVersions” value=“3” />
<Parameter name=“NeighborhoodVersionValue” value=“0” />
<Parameter name=“NeighborhoodCurrentVersionName” value=“Random variable and

random value” />

</ParameterSection>
</SearchComponent>

</SearchComponent>

</SearchComponent>

</SearchComponent>

</SearchComponent>
</Search>

An XML file so created can be stored on, e.g. a web server; thereafter the algorithm can be exchanged with other users and can be reused on a different platform.

Such XML files can also be read, and graphical representation 1201 thereof created and displayed by the GUI 1103. Accordingly the GUI 1103 has a second

An XML file so created can be stored on, e.g. a web server; thereafter the algorithm can be exchanged with other users and can be reused on a different platform.

Such XML files can also be read, and graphical representation 1201 thereof created and displayed by the GUI 1103. Accordingly the GUI 1103 has a second menu option, which, when selected, causes the selecting program 1101 to read an XML file and create a record R, which can be displayed by the GUI 1103.

The selecting program 1101 has access to several Application Programming Interfaces (API) (javax.xml, org.w3c.dom, com.sun.xml and org.xml.sax which are

normally available from the Java Development Kit (jdk) 1.4 API), which comprise methods for parsing XML files and creating a parent/child list of objects corresponding thereto (which in this embodiment is the record R). The parsed list can be displayed as a tree of objects, as shown in FIGS. 12a, 12b and 14.

The skilled person will realize that other structured mark-up languages could be used; for example, the Standard Generalized Markup Language (SGML), the Resource Document Framework (RDF), which is a language with specialised mark-up tags for formatting and exchanging information about resource document, and.

Dynamic HTML (DHTML), which is a proprietary Microsoft Markup language that attaches attributes to tags and, like XML, allows user-definable tags.

Appendix A1

A selection of virtual methods that are implemented and instantiated by parts 203

public SearchComponent getParent( ); //Returns the search component parent of this search component.

public void setParent(SearchComponent parent); //Sets the search component parent of this search component.

public List getchildren( ); //Returns the list of search components children of this component.

public void initialise( ); //lnitialises this search component and all of its children recursively.

public boolean stoppingCondition( ); //Tests whether the stopping conditions of this search component or its parent are verified. If so it returns true. Returns false otherwise.

public String getName( ); //Returns the name of this search component.

public boolean add(SearchComponent sc); //Adds a search component to this search component. By Default, this function returns false and must be overriden by any search component that will allow the addition of search components.

public boolean remove(SearchComponent sc); //Removes a search component from the list of children of this search component. By Default, this function returns false and must be overriden by any search component that will allow removals.

public boolean isValid( ) 21; //Returns true if this component is valid in a sense that it verifies all the requirements described in the header of its class, and all its children are valid as well. It returns false otherwise.

public int getNOfParameters( ); //Returns the number of parameters associated with this search component.

public String getParameterValue(int i); //Returns the value of the ith parameter in a String.

public void setParameterValue(int i, String value) throws Exception; //Sets the value of the ith parameter. “value” could represent a long, a double or a real value coded into a String.

public int getNOfVariables( ); //Returns the number of Variables.

Appendix A2

The appendix includes an extended example of parts 203 available in the database DB1. This list is not exhaustive, as the part creator 205 can be invoked to create new parts, which will subsequently be added to the database DB1 in the manner described above.

Class Hierarchy
class com.bt.hs.SearchComponent

□ class com.bt.hs.aspiration.Aspiration
□ class com.bt.hs.crossover.Crossover

□ class com.bt.hs.crossaver.Bipoint
□ class com.bt.hs.crossaver.IUS
□ class com.bt.hs.crossover.Monopoint
□ class com.bt.hs.crossover.Uniform

□ class com.bt.hs.objectivevalue.DynamicObjectiveValue

□ class com.bt.hs.objectivevalue.ProblemGLS

□ class com.bt.hs.mutation.Mutation

□ class com.bt.hs.mutation.SingleNeighborhoodSearchMutation
□ class com.bt.hs.mutation.SingleSolutionMethodMutation

□ class com.bt.hs.neighborhood.Neighborhood

□ class com.bt.hs.neighborhood.PositionAssignMoveNeighborhood
□ class com.bt.hs.neighborhood.PositionMoveAtMoveNeighborhood
□ class com.bt.hs.neighborhood.PositionSwapMoveNeighborhood
□ class com.bt.hs.neighborhood.VariableIndexAssignMoveNeighborhood
□ class com.bt.hs.neighborhood.VariableIndexMoveAtMoveNeighborhood
□ class com.bt.hs.neighborhood.VariableIndexSwapMoveNeighborhood

□ class com.bt.hs neighborhoodsearch.NeighborhoodSearch

□ class com.bt.hs.neighborhoodsearch.CompositeNeighborhoodSearch

□ class com.bt.hs.neighborhoodsearch.PerformAllCNS
□ class com.bt.hs.neighborhoodsearch.PerformBestOfAllCNS

□ class com.bt.hs.neighborhoodsearch.SingleNeighborhoodSearch

□ class com.bt.hs.neighborhoodsearch.AspirationPlus

□ class com.bt.hs.neighborhoodsearch.CircularAspirationPlus
□ class com.bt.hs.neighborhoodsearch.RestartAspirationPlus

□ class com.bt.hs.neighborhoodsearch.BestImprovement
□ class com.bt.hs.neighborhoodsearch.BestMoveNeighborhoodSearch
□ class com.bt.hs.neighborhoodsearch.CircularFirstImprovernent
□ class com.bt.hs.neighborhoodsearch.FirstImprovement
□ class com.bt.hs....borhoodsearch.FirstLegalMoveNeighborhoodSearch
□ class com.bt.hs....borhoodsearch.RestartFirstImprovement
□ class com.bt.hs.neighborhoodsearch.ThresholdNeighborhoodSearch

□ class com.bt.hs....borhoodsearch.InvariantSimulatedAnnealing

□ class com.bt.examples.cs.CarSeguencingISA

□ class com.bt.hs.PopulationMethod
□ class com.bt.hs.CompositePopulationMethod

□ class com.bt.hs.CrossoverPopulationMethod
□ class com.bt.hs.Gen rationPopulationMethod
□ class com.bt.hs.MutationPopulationMethod
□ class com.bt.hs.SearchR startPopulationMethod
□ class com.bt.hs.S lectionPopulationMethod

□ class com.bt.hs.populationrestart.PopulationSearchRestart

□ class com.bt.hs.populationrestart.PopulationReduceRestart

□ class com.bt.hs.Search

□ class com.bt.hs.PopulationHeuristicSearch
□ class com.bt.hs.SingleSolutionHeuristicSearch

□ class com.bt.hs.restart.SearchRestart

□ class com.bt.hs.restart.ReduceRestart

□ class com.bt.examples.fa.SelectableValuesReduceRestart

□ class com.bt.hs.selection.Selection

□ class com.bt.hs.selection.RandomSelection
□ class com.bt.hs.selection.SuSSelection

□ class com.bt.hs.SingleSolutionMethod

□ class com.bt.hs.CompositeSingleSolutionMethod
□ class com.bt.hs.GenerationSingleSolutionMethod

□ class com.bt.hs.SSG UsingConstruction
□ class com.bt.hs.SSG UsingCurrentProblem
□ class com.bt.hs.SSG UsingRandom

□ class com.bt.hs.LocalSearch

□ class com.bt.hs.ReduceConflictLocalSearch

□ class com.bt.hs.PerturbationSingleSolutionMethod
□ class com.bt.hs.SearchRestartSingleSolutionMethod

□ class com.bt.hs.taboo.Taboo

□ class com.bt.hs.taboo.IntegerAssignmentTaboo
□ class com.bt.hs.taboo.SeguencesPositionTaboo

Appendix A3

Method Summary

| | |
|---|---|
| void | dragDropEnd(DragSourceDropEvent dsde) |
| | This method is invoked to signify that the Drag and Drop operation |
| | is complete. |
| void | dragEnter(DragSourceDragEvent dsde) |
| | Called as the hotspot enters a platform dependent drop site. |
| void | dragExit(DragSourceEvent dse) |
| | Called as the hotspot exits a platform dependent drop site. |
| void | dragOver(DragSourceDragEvent dsde) |
| | Called as the hotspot moves over a platform dependent drop site. |
| void | dropActionChanged(DragSourceDragEvent dsde) |
| | Called when the user has modified the drop gesture. |

dragEnter

public void dragEnter(DragSourceDragEvent dsde)

Called as the hotspot enters a platform dependent drop site. This method is invoked when the following conditions are true:

The logical cursor's hotspot initially intersects a GUI Component's visible geometry.

That Component has an active DropTarget associated with it.

The DropTarget's registered DropTargetListener dragEnter( ) method is invoked and returns successfully.

The registered DropTargetListener invokes the DropTargetDragEvent's acceptDrag( ) method to accept the drag based upon interrogation of the source's potential drop action(s) and available data types (DataFlavors).

Parameters:

dsde—the DragSourceDragEvent

dragOver

public void dragOver(DragSourceDragEvent dsde)

Called as the hotspot moves over a platform dependent drop site. This method is invoked when the following conditions are true:

The cursor's logical hotspot has moved but still intersects the visible geometry of the Component associated with the previous dragEnter( ) invocation.

That Component still has a DropTarget associated with it.

That DropTarget is still active.

The DropTarget's registered DropTargetListener dragover( ) method is invoked and returns successfully.

The DropTarget does not reject the drag via rejectDrag( )

Parameters:

dsde—the DragSourceDragEvent

dropActionChanged

public void dropActionChanged(DragSourceDragEvent dsde)

Called when the user has modified the drop gesture. This method is invoked when the state of the input device(s) that the user is interacting with changes. Such devices are typically the mouse buttons or keyboard modifiers that the user is interacting with.

Parameters:

dsde—the DragSourceDragEvent

dragExit

public void dragExit(DragSourceEvent dse)

Called as the hotspot exits a platform dependent drop site. This method is invoked when the following conditions are true:

The cursor's logical hotspot no longer intersects the visible geometry of the Component associated with the previous dragEnter( ) invocation. OR

The Component that the logical cursor's hotspot intersected that resulted in the previous dragEnter( ) invocation no longer has an active DropTarget or DropTargetListener associated with it. OR

The current DropTarget's DropTargetListener has invoked rejectDrag( ) since the last dragEnter( ) or dragover( ) invocation.

Parameters:

dse—the DragSourceEvent

dragDropEnd

public void dragDropEnd(DragSourceDropEvent dsde)

This method is invoked to signify that the Drag and Drop operation is complete. The getDropSuccesso method of the DragSourceDropEvent can be used to determine the termination state. The getDropAction( ) method returns the operation that the DropTarget selected (via the DropTargetDropEvent acceptDrop( ) parameter) to apply to the Drop operation. Once this method is complete, the current DragSourceContext and associated resources become invalid.

Parameters:

dsde—the DragSourceDropEvent

Appendix A4

Ontology for XML used in embodiments of the invention

The ontology comprises rules specifying valid tags, their attributes and valid combinations of tags (in sequence or otherwise).

The ontology is consistent with the convention specified by the W3C recommendation (see XML recommendation on the reference W3C web site http://xml.coverpages.org/XMLSpecDTD.html) and is stored in a so-called document type definition file (.DTD file).

Example:

<!-- DTD for Heuristic Search -->
<!--
#############################
ELEMENTS DECLARATION
#############################
-->
<!ELEMENT Search (Description? , SearchComponent) >
<!ATTLIST Search

xmlns CDATA #FIXED “http://132.146.246.235”

>
<!ELEMENT Description (#PCDATA) >
<!--
#############################
SEARCH COMPONENT DECLARATION
#############################
-->
<!ELEMENT SearchComponent ( ParameterSection,
SearchComponent* ) >
<!ATTLIST SearchComponent name CDATA #REQUIRED >
<!ELEMENT ParameterSection (Parameter*) >
<!ELEMENT Parameter EMPTY >
<!ATTLIST Parameter

name CDATA #REQUIRED
value CDATA #REQUIRED

>
1) Tag definition (rule headed by <!ELEMENT):

A tag includes a name and a value, which is defined either by a string or a sequence of tags (those tags are referred as the “contained” tags.) e.g. the tag named SEARCH must contain at most two tags, DESCRIPTION and SEARCHCOMPONENT.

The “?” after a tag name means that the tag is optional so, e.g., a tag SEARCH can contain attributes and optionally a tag SEARCHCOMPONENT.

2) Attributes of Tags are Specified into Rules Headed By <!ATTLIST)

There are several ways of specifying attributes: fixed value, required attribute, value not fixed but included into a set of constant values, not required, and no value imposed. Some examples are:

In the example above, the tag SEARCH has an attribute, called “xmlns”, whose value is fixed to the string “http://132.146.246.235”. This specifies where the ontology file (*.DTD file) is stored. In fact this attribute can specify a network address (IP address or a web site URL) or simply the path of a directory).

In the example above, tag DESCRIPTION: is an empty tag whose value is a string; this is inferred by the keyword #PCDATA in the DTD language.

In the example above, tag SEARCHCOMPONENT: as a PARAMETERSECTION tag followed by an infinite sequence of SEARCHCOMPONENT tags. Moreover a SEARCHCOMPONENT has one attribute, its username, which is stored in the attribute “name”. This attribute is mandatory.

3) Requirements of XML Files (Which Tags are Mandatory, Which Tags are Optional)

A valid XML file must start with a tag <SEARCH...>; rules defining a tag are thereafter applied to check that the XML file is built in accordance with the DTD grammar.

When the selecting program 1101 reads an XML file and creates a record R, firstly the selecting program 1101 checks the tag sequence in the XML file. Accordingly, the XML file includes in its header a pointer to the DTD file (defined in tag <DOCTYPE...>), which contains the ontology that the XML file has to follow.

1. A system for building an algorithm to apply to an optimisation problem in order to find a solution thereto, the or each algorithm comprising a plurality of components, the system comprising:
means for creating parts corresponding to at least some of the components,
a store for storing the created parts, and
means arranged to select from said stored parts in order to build an algorithm therefrom,
wherein each part comprises co-operating means arranged to cooperate with other parts and effecting means arranged to effect a change to a solution to the optimisation problem, and wherein each part is arranged such that the effecting means is independent of the operation of any other part.

2. A system according to claim 1, wherein each part comprises a validation process arranged to validate interoperability between cooperating parts.

3. A system according to claim 1 or claim 2, wherein the store is arranged to store the created parts in accordance with the functional relationship between their respective effecting means.

4. A system according to any one of the preceding claims further including
a graphical user interface arranged to display, in a first region, the parts stored in the store and to display, in a second region, a representation of said selected parts constituting the built algorithm,
means responsive to movement of a part in the first region to the second region, and
graphical connecting means arranged to graphically connect the moved part to one of the selected parts in the second region.

5. A system according to claim 4, wherein the graphical connecting means is arranged to identify which of the selected parts in the second region the moved part is released onto, and the identified part is arranged process said validation process so as to perform an interoperability check between itself and the moved part.

6. A system according to any one of the preceding claims, further including means arranged to store the selected parts constituting the built algorithm as sets of information enclosed by tags of a hierarchical tag structure defined in accordance with a structured mark-up language, thereby saving a representation of the built algorithm.

7. A system according to any one of the preceding claims, further including identifying means for identifying components that are to constitute the or each algorithm.

8. A system according to claim 7, further including means for comparing parts in the store with the identified components, so that, if a part corresponding to an identified component exists in the store, a part corresponding to the identified component is not created.

9. A system according to any one of the preceding claims, wherein the effecting means of one or more selected parts is arranged to apply an incremental move to a current solution.

10. A system according to any one of the preceding claims, wherein more than one solution to the optimisation problem is generated, and the effecting means is arranged to combine one of the generated solutions with at least one other generated solution.

11. A method of building an algorithm to apply to an optimisation problem, the method comprising the steps of
identifying components constituting the algorithm,
selecting parts corresponding to the identified components, wherein each part comprises co-operating means arranged to cooperate with other parts and effecting means arranged to effect a change to a solution to the optimisation problem, and wherein each part is arranged such that the effecting means thereof is independent of the operation of any other part, and
connecting respective co-operating means of the selected parts together so as to build the algorithm.

12. A method according to claim 11, further including validating interoperability between the selected parts.

13. A method according to claim 11 or claim 12, further including displaying in a first region, parts available for selection and in a second region, a representation of said selected parts constituting the built algorithm,
monitoring movement of a part in the first region to the second region, and, when such a movement is detected, identifying which of the selected parts in the second region the moved part is released onto, and
graphically connecting the moved part to the identified part.

14. A method according to any one of claims 11 to 13, further including receiving data identifying parameters of the selected parts.

15. A method including any one of claims 11 to 14, further including storing the selected parts constituting the built algorithm as sets of information enclosed by tags of a hierarchical tag structure defined in accordance with a structured mark-up language, thereby saving a representation of the built algorithm.
